(19) United States
(12) Patent Application Publication
(10) Pub. No.: US 2005/0257144 A1
(43) Pub. Date: Nov. 17, 2005

(54) Driver of image forming apparatus capable of printing selected objects of document, and image forming system for and method of printing selected objects of document

(75) Inventors: Don-scon Lee, Yongin-si (KR); Jeong-sang Kim, Suwon-si (KR); Seung-wan Lee, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/128,247

(22) Filed: May 13, 2005

(30) Foreign Application Priority Data
May 14, 2004 (KR) 2004-34384

(51) Int. Cl. G06F 17/00; G06F 3/00

(52) U.S. Cl. 715/527; 710/8; 715/542

(57) ABSTRACT

A driver of an image forming apparatus capable of printing only selected objects of a document, and an image forming system for and a method of printing selected objects of a document are disclosed. The image forming system capable of printing selected objects of a document has a user interface unit for providing an options menu that offers a plurality of objects to choose from, and a driver unit for generating a command to print an object selected through the user interface unit, and the image forming unit for interpreting and rendering the command generated by the driver unit. Thus, a user can print only selected objects of a document.

### CROSS-REFERENCE TO RELATED APPLICATION

This application claims the benefit under 35 U.S.C. §119(a) of Korean Patent Application No. 10-2004-0034384, filed on May 14, 2004, in the Korean Intellectual Property Office, the entire disclosure of which is incorporated herein by reference.

### BACKGROUND OF THE INVENTION

1. Field of the Invention

The present invention relates to an image forming apparatus and method. More particularly, the present invention relates to a driver of an image forming apparatus capable of printing selected objects of a document, and an image forming system for and a method of printing selected objects of a document.

2. Description of the Related Art

The introduction of various application programs has made it possible to create and edit diverse and numerous objects using a computer. Accordingly, documents created by those application programs have become more complicated. When a user prints a document containing a plurality of objects by using a conventional image forming apparatus, a driver of the image forming apparatus drives the printer to print all of the objects.

However, since a complicated document typically comprises objects unnecessary to a user, such as banner ads or vector information, as well as objects necessary to the user, there is no need for the user to print all of the objects. Rather, the user may wish to print only the objects that he or she finds necessary. Besides, printing all of the objects including the objects unnecessary to the user may confuse the user. It is also uneconomical to print unnecessary objects since they entail the unnecessary use of a printing medium as well as toner or the like. A user may more often desire to print a document without unnecessary objects.

### SUMMARY OF THE INVENTION

The present invention provides a driver driving an image forming apparatus to print only objects necessary to a user while eliminating unnecessary objects such as banner ads or vector information.

The present invention also provides an image forming system capable of printing the objects necessary to a user.

The present invention also provides a method for printing the objects considered necessary by a user.

According to an aspect of the present invention, there is provided a driver for driving an image forming apparatus to print selected objects of a document. The driver comprises a user interface unit for providing an options menu that offers a plurality of objects to choose from; and a driver unit for generating a command to print an object selected through the user interface unit.

At least one of a font object, a graphics object, and a vector object can be selected from the options menu. The options menu provided by the user interface unit can further comprise an absolute position option for printing the at least one object selected from the options menu provided by the user interface unit adjacent to a previous object printed before the at least one object, and the driver unit can generate a command for printing the at least one object and the previous object consecutively and adjacently based on information regarding a position of the previous object and a position of the at least one object when the absolute position option is selected.

The options menu provided by the user interface unit can further comprise a user-defined position option for printing the at least one object selected from the options menu provided by the user interface unit at a predetermined position, a position coordinate field where a user can input a position coordinate value is provided when the user-defined option is selected, and the driver unit can generate a command for printing the at least one object at a location corresponding to the position coordinate value input to the position coordinate field when the user-defined position option is selected.

According to another aspect of the present invention, there is provided an image forming system capable of printing selected objects of a document. The image forming system comprises a user interface unit for providing an options menu that offers a plurality of objects to choose from; a driver unit for generating a command to print an object selected through the user interface unit; and the image forming unit for interpreting and rendering the command generated by the driver unit.

The image forming system can further comprise a spooler for transmitting the command generated by the driver unit to the image forming unit, and the image forming unit can interpret and render the command received from the spooler.

According to another aspect of the present invention, there is provided a method for printing selected objects of a document using an image forming apparatus. The method comprises the steps of providing an options menu that offers a plurality of objects to choose from; generating a command to print an object when the object is selected from the options menu; and interpreting and rendering the command.

In the steps of providing the options menu, at least one of a font object, a graphicsobject, and a vector object can be selected from the options menu. The options menu can further comprise an absolute position option for printing the at least one object selected from the options menu provided by a user interface unit adjacent to a previous object that will be printed before the at least one object, and, in the generating of the command, a command for printing the at least one object and the previous object consecutively and adjacently can be generated based on information regarding a position of the previous object and a position of the at least one object when the at least one object is selected from the options menu and the absolute position option is selected.

The options menu can further comprise a user-defined position option for printing the at least one object selected from the options menu provided by the user interface unit at a predetermined position, and the generating of the command can comprise the steps of providing a position coordinate field where a user can input a position coordinate value of the at least one object when the user-defined position option is selected; and generating a command for printing the at least one object at a location corresponding to the position coordinate value input to the position coordinate field.

According to another aspect of the present invention, there is provided a computer-readable recording medium on which a program for executing the method is recorded.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of an image forming system according to an embodiment of the present invention;

FIG. 2 is a block diagram of a driver of an image forming apparatus capable of printing selected objects of a document according to an embodiment of the present invention

FIG. 3 illustrates an options menu window produced by a user interface unit according to embodiments of the present invention;

FIG. 4 is a block diagram of an image forming system comprising the driver of FIG. 2 according to an embodiment of the present invention;

FIG. 5 is a flowchart illustrating a method for printing selected objects of a document using an image forming apparatus according to an embodiment of the present invention;

FIG. 6 is a flowchart illustrating a method for printing only selected objects of a document according to an embodiment of the present invention;

FIG. 7 is a flowchart illustrating a method for printing selected objects of a document in consideration of absolute position information according to an embodiment of the present invention; and

FIG. 8 is a flowchart illustrating a method for printing selected objects of a document in consideration of information regarding a user-defined position according to an embodiment of the present invention.

Throughout the drawings, it should be understood that like reference numbers refer to like features, structures and elements.

### DETAILED DESCRIPTION OF EXEMPLARY EMBODIMENTS

The present invention will now be described more fully with reference to the accompanying drawings, in which exemplary embodiments of the invention are shown. The invention may, however, be embodied in many different forms and should not be construed as being limited to the embodiments set forth therein; rather, these embodiments are provided so that this disclosure will be thorough and complete, and will fully convey the concept of the invention to those skilled in the art.

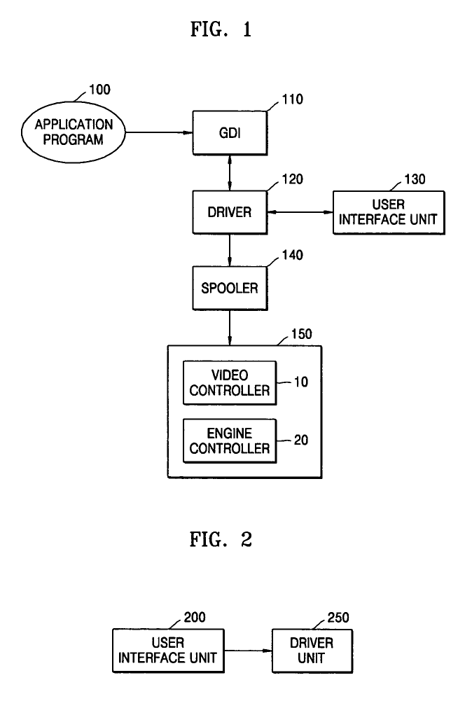

FIG. 1 is a block diagram of an image forming system according to an embodiment of the present invention. The image forming system comprises an application program 100, a graphics device interface (GDI) 110, a driver 120, a user interface unit 130, a spooler 140, and an image forming apparatus 150.

The application program 100, which is a computer program, creates and edits objects that can be printed by the image forming apparatus 150. The GDI 110 is a program typically present in an operating system of a computer. The GDI 110 receives an object from the application program 100 and transmits the object to the driver 120, which then generates a command for the object that the image forming apparatus 150 requests.

The driver 120 is a computer program and uses commands that the image forming apparatus 150 can interpret. The user interface unit 130 for the driver 120 provides an environmental factor with which the driver 120 can generate a command.

The spooler 140 is a program existing in an operating system of a computer and transmits a command generated by the driver 120 to a physical input and output device connected to the image forming apparatus 150. The image forming apparatus 150 can be a printer and comprises a video controller 10 and an engine controller 20. The video controller 10 interprets a command generated by the driver 120, converts the command into a bitmap, and transmits the bitmap to the engine controller 20. The engine controller 20 receives the bitmap from the video controller 10 and transmits the bitmap to a printing media.

Specifically, with the help of the GDI 110, the driver 120 generates a command that the video controller 10 can interpret. A command is generated for each object. Each object is composed of a font, a graphics, and a vector. The generated command is transmitted to the video controller 10, which then converts the command into a bitmap. The video controller 10 transmits the bitmap to the engine controller 20, and the engine controller 20 transmits the bitmap to a printing medium, which then prints the bitmap.

FIG. 2 is a block diagram of a driver of an image forming apparatus capable of printing selected objects of a document according to an embodiment of the present invention. Referring to FIG. 2, the driver comprises a user interface unit 200 and a driver unit 250. The user interface unit 200 is a user interface of the driver and provides an options menu listing a plurality of objects to select for printing.

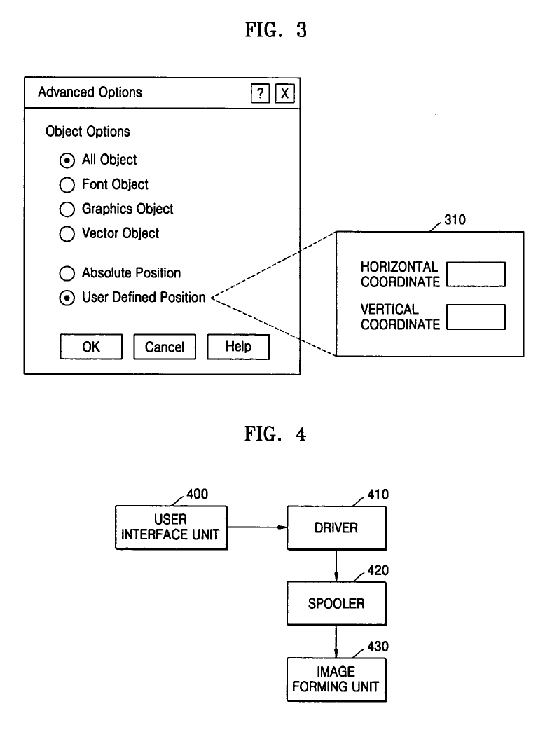

FIG. 3 illustrates an options menu window provided by the user interface unit 200. At least one of a font object, a graphics object, and a vector object in the options menu provided by the user interface unit 200 may be selected. In other words, one, two, or all of the font, graphics, and vector objects may be selected.

The options menu provided by the user interface unit 200 can also comprise an absolute position option. The absolute position option is selected when a user desires to print objects selected from the options such that consecutive objects are printed adjacent to each other. Therefore, the selected object can be printed at its absolute position regardless of positions of other objects.

The options menu provided by the user interface unit 200 may further comprise a user-defined position option. The user-defined position option is selected when a user desires to print an object selected from the options menu at a desired location. To this end, when the user-defined position option is selected, a position coordinate field 310 is provided such that a user can input a position coordinate value therein.

The driver unit 250 is a driver of the image forming apparatus. When a user selects at least one object from the options menu provided by the user interface unit 200, the driver unit 250 generates a command to print the selected object. For example, the driver unit 250 generates a command for the selected object that the image forming apparatus, such as a printer, can interpret and render. Therefore, the driver unit 250 determines which objects are selected from the user interface unit 200 and does not generate commands for objects that are not selected.

When a user selects the absolute position option from the options menu, the driver unit 250 generates a command based on position information of a selected object and a previous object to print the selected and previous objects consecutively and adjacently. When the user selects the user-defined position option and inputs a position coordinate value into the position coordinate field 310, the driver unit 250 generates a command for printing the selected object at a location corresponding to the position coordinate value.

FIG. 4 is a block diagram of an image forming system comprising the driver of FIG. 2 according to an embodiment of the present invention. The image forming system comprises a user interface unit 400, a driver 410, a spooler 420, and an image forming unit 430.

The user interface unit 400 and the driver 410 are preferably identical to the driver of FIG. 2. The spooler 420 transmits a command generated by the driver 410 to the image forming unit 430. The image forming unit 430 interprets and renders the command received from the spooler 430.

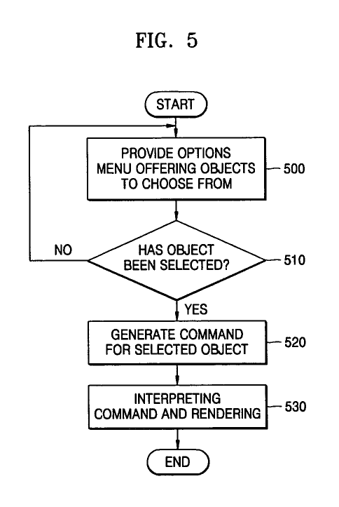

FIG. 5 is a flowchart illustrating a method for printing selected objects of a document using an image forming apparatus according to an embodiment of the present invention. Operations of the image forming system and its driver will be described with reference to FIG. 5.

The user interface unit 200 or 400 provides an options menu offering a plurality of objects for the user to choose (Operation 500). When a user selects at least one object from the options menu provided by the user interface unit 200 or 400 (Operation 510), the driver 250 or 410 generates a command for the selected object (Operation 520). The command is interpreted, the objects are rendered, and then printed by the image forming unit 430 (Operation 530).

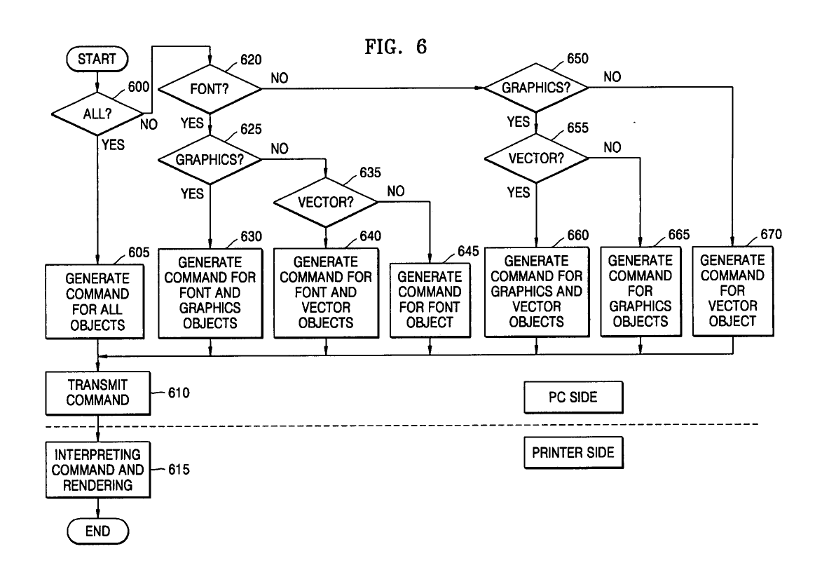

This process will now be described in more detail according to an embodiment of the present invention. FIG. 6 is a flowchart illustrating a method for printing only selected objects of a document according to an embodiment of the present invention. When a user desires to print all objects of a document, the user selects all of the font, graphics, and vector objects in the options menu provided by the user interface unit 200 or 400 of the driver 250 or 410, respectively (Operation 600). Then, the driver 250 or 410 generates a command for all of the objects when the user selects that option (Operation 605). The command thus generated is transmitted to the image forming unit 430 via the spooler 420 (Operation 610). The image forming unit 430 interprets, renders, and prints the command (Operation 615).

When a user desires to print the font object and the graphics object, the user selects the font and the graphics objects in the options menu provided by the user interface unit 200 or 400 (Operations 620 and 625, respectively). Then, the driver 250 or 410 generates a command for the font and graphics objects (Operation 630). In this case, the driver 250 or 410 does not generate a command for the vector object.

When a user desires to print the font object and the vector object only, the user selects the font and the vector objects in the options menu (Operations 620 and 635, respectively). Then, the driver 250 or 410 generates a command for the font and the vector objects (Operation 640). In this case, the driver 250 or 410 does not generate a command for the graphics object.

When a user desires to print the font object only, the user selects the font object in the options menu provided by the interface unit 200 or 400 (Operations 620). Then, the driver 250 or 410 generates a command for the font object (Operation 645). In this case, the driver 250 or 410 does not generate a command for the graphics and vector objects.

When a user desires to print the graphics object and the vector object, the user selects the graphics and vector objects in the options menu provided by the interface unit 200 or 400 (Operations 650 and 655, respectively). Then, the driver 250 or 410 generates a command for the graphics and vector objects (Operation 655). In this case, the driver 250 or 410 does not generate a command for the font object.

When a user desires to print the graphics object only, the user selects the graphics object in the options menu (Operation 650). Then, the driver 250 or 410 generates a command for the graphics object (Operation 665). In this case, the driver 250 or 410 does not generate a command for the font and vector objects.

Finally, when a user desires to print the vector object, the user selects the vector object in the options menu. Then, the driver 250 or 410 generates a command for the vector object (Operation 670). In this case, the driver 250 or 410 does not generate a command for the font and graphics objects.

When the driver 250 or 410 generates a command according to each case (Operations 605, 630, 640, 645, 660, 665, or 670), the command is transmitted to the image forming unit 430 via the spooler 420 (Operation 610). The command is interpreted, rendered, and printed on a printing medium by the image forming unit 430 (Operation 615). Here, a default value may be set such that a command for all objects is generated.

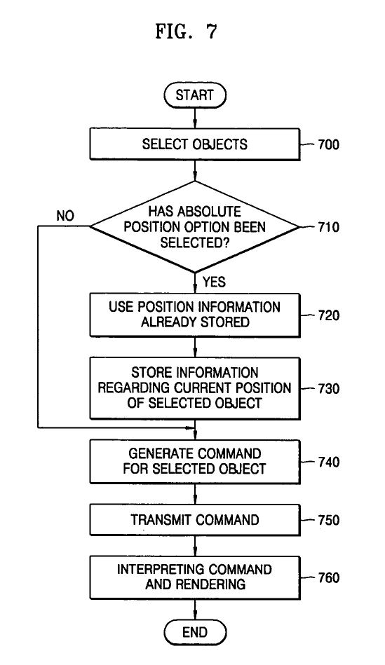

A case where a user selects the absolute position option from the options menu provided by the user interface unit 200 or 400 after selecting at least one of the font, graphics, and vector objects will now be described with reference to FIG. 7. FIG. 7 is a flowchart illustrating a method for printing selected objects of a document in consideration of absolute position information according to an embodiment of the present invention.

First, a user selects at least one of the font, graphics, and vector objects (Operation 700). The position of each of the objects is determined based on information regarding the position of a previous object. However, when a user selects the absolute position option from the options menu provided by the user interface unit 200 or 400 (Operation 710), the driver 250 or 410 uses the information regarding the position of the previous object to set the position of a subsequent object when generating a command for a selected object (Operation 720). To this end, the absolute positions of commands already generated are recorded and stored (Operation 730), and are used as a basis for determining the position of a next object and generating a next command.

After being generated (Operation 740), the command is transmitted to the image forming unit 430 via the spooler 420 (Operation 750). Then, the command is interpreted, rendered, and printed (Operation 760).

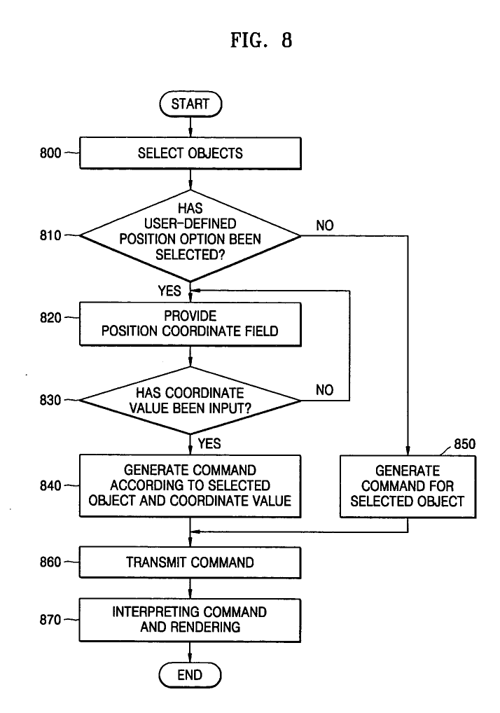

Finally, a case where a user selects the user-defined position option from the options menu provided by the user interface unit 200 or 400 after selecting at least one of the font, graphics, and the vector objects as illustrated in FIG. 6 will be described with reference to FIG. 8. FIG. 8 is a flowchart illustrating a method for printing selected objects of a document in consideration of information regarding a user-defined position according to an embodiment of the present invention.

First, a user selects at least one of the font, graphics, and vector objects (Operation 800). The position of each of the objects is determined based on information regarding the position of a previous object. However, when a user selects the user-defined position option from the options menu provided by the user interface unit 200 or 400, (Operation 810), the user interface unit 200 or 400 provides the position coordinate field 310 to allow the user to enter data via the user-defined position option when generating a command for a selected object (Operation 820).

When the user inputs to the position coordinate field 310 a coordinate value corresponding to a location where the selected object will be printed (Operation 830), the driver 250 or 410 generates a command for the selected object and the coordinate value (Operation 840). The command thus generated is transmitted to the image forming unit 430 via the spooler 420 (Operation 860). Then, the command is interpreted, rendered, and printed (Operation 870).

If the user does not select the user-defined position option in Operation 810, the driver 210 or 410 generates a command for the selected object as illustrated in FIG. 6 (Operation 850) and performs Operation 860.

Embodiments of the present invention can also be implemented as computer-readable codes on a computer-readable recording medium. The computer-readable recording medium is any data storage device that can store data which can be thereafter read by a computer system. Examples of the computer-readable recording medium include read-only memory (ROM), random-access memory (RAM), CD-ROMs, magnetic tapes, floppy disks, and optical data storage devices.

According to embodiments of the present invention, a user can print only selected objects of a document. Since it is possible to print information necessary to a user without information unnecessary to the user, such as banner ads or vector information, user convenience is enhanced.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A driver for driving an image forming apparatus to print selected objects of a document, the driver comprising:
a user interface unit for providing an options menu that offers a plurality of objects from which to choose; and
a driver unit for generating a command to print an object selected through the user interface unit.

2. The driver of claim 1, wherein at least one of a font object, a graphics object, and a vector object can be selected from the options menu.

3. The driver of claim 2, wherein the options menu provided by the user interface unit further comprises an absolute position option for printing the at least one object selected from the options menu provided by the user interface unit adjacent to a previous object printed before the at least one object, and the driver unit generates a command for printing the at least one object and the previous object consecutively and adjacently based on information regarding a position of the previous object and a position of the at least one object when the absolute position option is selected.

4. The driver of claim 2, wherein the options menu provided by the user interface unit further comprises a user-defined position option for printing the at least one object selected from the options menu provided by the user interface unit at a predetermined position, a position coordinate field where a user can input a position coordinate value is provided when the user-defined option is selected, and the driver unit generates a command for printing the at least one object at a location corresponding to the position coordinate value input to the position coordinate field when the user-defined position option is selected.

5. An image forming system capable of printing selected objects of a document, the image forming system comprising:
a user interface unit for providing an options menu that offers a plurality of objects to choose from;
a driver unit for generating a command to print an object selected through the user interface unit; and the image forming unit for interpreting and rendering the command generated by the driver unit.

6. The image forming system of claim 5, further comprising a spooler transmitting the command generated by the driver unit to the image forming unit, wherein the image forming unit interprets and renders the command received from the spooler.

7. A method for printing selected objects of a document using an image forming apparatus, the method comprising the steps of:
providing an options menu that offers a plurality of objects to choose from;
generating a command to print an object when the object is selected from the options menu; and
interpreting and rendering the command.

8. The method of claim 7, wherein the step of providing an options menu comprises providing at least one of a font object, a graphics object, and a vector object can be selected from the options menu.

9. The method of claim of 8, wherein the options menu further comprises an absolute position option for printing the at least one object selected from the options menu provided by a user interface unit adjacent to a previous object that will be printed before the at least one object, and, in the generating of the command step generating a command for printing the at least one object and the previous object consecutively and adjacently is generated based on information regarding a position of the previous object and a position of the at least one object when the at least one object is selected from the options menu and the absolute position option is selected.

10. The method of claim 8, wherein the options menu further comprises a user defined position option for printing the at least one object selected from the options menu provided by the user interface unit at a predetermined position, and the generating of the command comprises the steps of:
providing a position coordinate field where a user can input a position coordinate value of the at least one object when the user-defined position option is selected; and generating a command for printing the at least one object at a location corresponding to the position coordinate value input to the position coordinate field.

11. A computer-readable recording medium on which a program for executing a method for printing selected objects of a document using an image forming apparatus, the method comprising the steps of:
providing an options menu that offers a plurality of objects to choose from;
generating a command to print an object when the object is selected from the options menu; and
interpreting and rendering the command.
